(19) United States
(12) Patent Application Publication
(10) Pub. No.: US 2016/0374515 A1
(43) Pub. Date: Dec. 29, 2016

(54) Removable Blender Pad

(71) Applicants: Rodney Joseph Stuart, Saint George, UT (US); Phillip Dietz, Saint George, UT (US)

(72) Inventors: Rodney Joseph Stuart, Saint George, UT (US); Phillip Dietz, Saint George, UT (US)

(21) Appl. No.: 14/748,455

(22) Filed: Jun. 24, 2015

(51) Int. Cl. A47J 43/07; B01F 15/00; B01F 15/06

(52) U.S. Cl. CPC A47J 43/0716; B01F 15/065; B01F 15/00662; B01F 2015/061; B01F 2215/0014

(57) ABSTRACT

This invention reduces the noise and vibration from a blender. One embodiment of a blender pad which has an air inlet and an air exhaust opening which corresponds with air inlet and exhaust ports in a blender. In addition, positioned between the exhaust port and exhaust opening is an acoustic chamber, and acoustics ridge with attenuating sound foam. The blender pad is releasably connected to a blender base.

### BACKGROUND OF THE INVENTION

Field of the Invention

A removable blender pad that limits the noise and vibration generated by a blender that is used for mixing and manipulating food.

Background—Prior Art

Blenders are popular mechanical devices to quickly mix or dice a variety of food items. Most blenders include a blender based or motor housing that contains an electric motor. The blender base has controls that control operation of an electric motor. A blender jar containing blades is located on the top of the blender base. In operation, a variety of food items can be placed inside the jar. The controls are then used to activate the electric motor. The electric motor turns the blades, mixing and dicing the food items.

To ensure the blender has the ability to mix and dice food, manufactures install powerful electrical motors. Many manufactures boast the strength of the electrical motors as an appeal to customers. While the powerful motors are an advantage, the motors do cause other drawbacks. The motor are the source of noise and vibrations. The noise generated may be so loud that it hurts the users ears or at the very least cause a nuisance the individuals near the blender. The vibration may cause the blender to move during operation, which can cause damage to the blender and a user. The vibrations between the blender and the surface that it is resting on causes additional noise.

Blenders required air flowing through the blender base to prevent overheating. The air is generally drawn through inlet and forced out of the blender through an air exhaust. Unfortunately, the movement of the air can amplify the sound of the motor. The airflow exiting the base of the food processor carries the loud noise to the exterior of the base and the noise is amplified by the surface the blender is sitting on.

When utilized in businesses, the noise and vibrations can disturb or distract customers. This has prevented business from utilizing blenders in business. At home, the noise and vibrations can disturb the household. Users may stop using the blender to altogether. While the manufactures have build blenders which limit the noise and vibration, such as placing insulation around a motor. the manufactures must balance the cost, power of the motor, and the size of the blender to match the average customer's desirers. If a consumer purchased a blender but wanted a blender which generated less noise or vibration, the only recourse for the consumer was to purchase another blender.

The present invention recognizes that it would be advantageous to allow the user to have device that the user could attached to a blender that would limit the noise and vibrations generated by the blender.

### SUMMARY OF THE INVENTION

The invention relates to a blender pad that is removably attaching to the base of a blender. The device is design to reduce noise and vibration from the blender.

One embodiment of the invention is the pad includes one or more air inlet or exhaust openings, acoustic sound chamber, acoustic ridges and attenuating damping foam. The air inlet and exhaust openings correspond to the exhaust port and exhaust opening located on a blender base. The acoustic chamber, acoustics ridge and attenuating damping foam aid in reducing the noise generated by the blender. The blender pad is made of materials such as rubber that absorbers the sound and vibrations of the blender. The blender pad is releasably connected to a blender base. Other embodiments are described and shown below.

### DESCRIPTION OF THE DRAWINGS

The invention may take form in certain parts and arrangement of parts and preferred embodiment of which will be described in detail in the specification and illustrated in the accompany drawing, which for a part hereof:

FIG. 1 shows a plan view of a blender pad with an exploded view of a blender base;

FIG. 2 shows a plan view of the blender pad attached to the blender motor;

FIG. 3 is a bottom view of the blender pad;

FIG. 4 is a top view of the blender pad;

FIG. 5 shows a bottom view of the blender pad;

FIG. 6 shows a cross sectional view, showing the blender pad attached to the blender base and an arrow line showing the path of the air flow;

FIG. 7 shows a bottom back view of the blender pad exploded from the blender base.

### DETAILED DESCRIPTION OF THE PREFERRED EMBODIMENTS

The present invention relates to a removable blender pad. In particular, the present invention relates to a device and methods that attaches to a blender to decreasing the noise and vibration produced by the blender.

In the flowing description of the invention, certain terminology is used for the purpose of reference only, and is not intend to be limiting. Terms such as “upper”, “lower”, “above”, and “below,” refer to directions in the drawings to which reference is made. Terms such as “inwards” and “outward” refer to directions towards and away from, respectively, the geometric center of the component described. Terms such as “side”, “top”, “bottom,” “horizontal,” “with in,” “inside,” and “vertical,” describe the orientation of portions of the component within a consistent but arbitrary frame of reference which is made clear by reference to the text and the associated drawings describing the component under discussion. Such terminology includes words specifically mentioned above, derivatives thereof, and words of similar import.

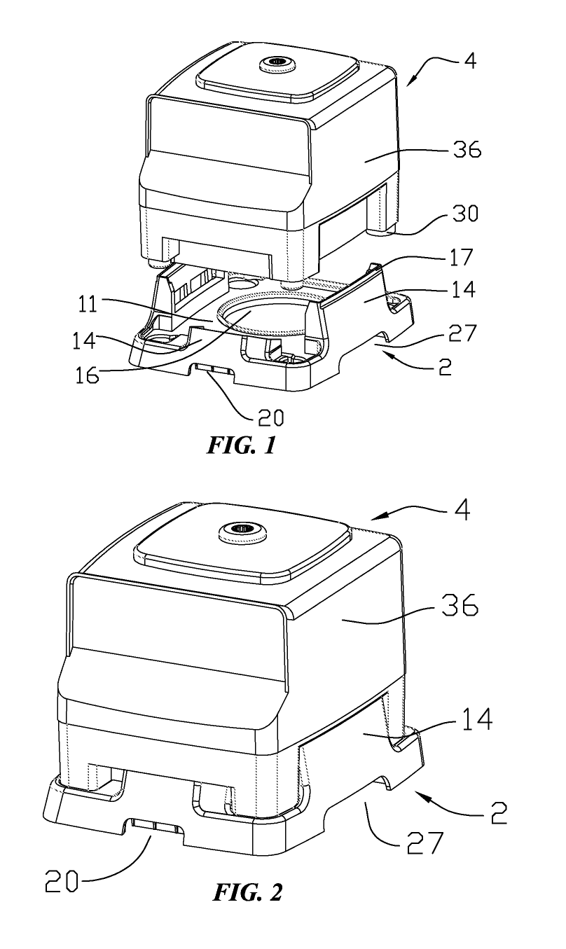

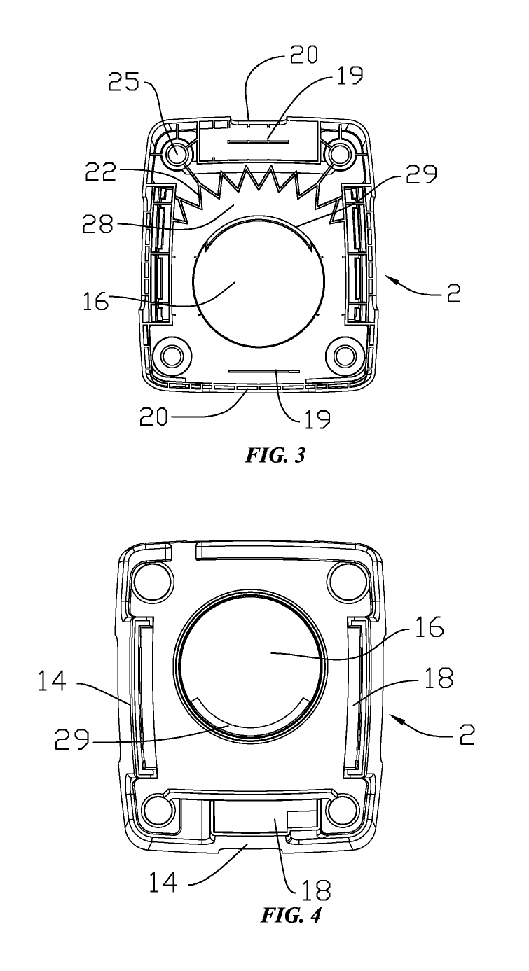

An embodiment of a blender pad 2 is illustrated in FIGS. 2 and 7 and in an exploded view of FIG. 1. A blender base 4 is generally configured to support a blender jar (not shown) and facilitate rotation of a blending blade in the blender jar. The blender jar is typically releasably attached to a blender base 4. The blender base 4 consist of at least one sidewall 36, in practice there are generally four sidewalls 36. The blender base 4 houses an electric motor 6. The motor 6 may be any type of motor known in the industry. The motor 6 is preferably controlled by a control panel, not shown, that is commonly located on the outside of the blender base 4. The blender base 4 usually rest on a surface 10 such as a cabinet or table top.

The blender base 4 is generally made of any appropriate material, such as molded plastic or metal. The blender base 4 may include features designed to facilitate airflow through the blender base 4. In addition, the blender base 4 may include hollow portions, ridged portions and openings, to create air gaps and pathways to direct the flow of air through the blender base 4.

The blender base 4 may include one or more feet 30. The feet 30 may be any appropriate size or shape and are generally located on the bottom of the blender base 4. The feet 30 are generally composed of material that would create friction, such as rubber.

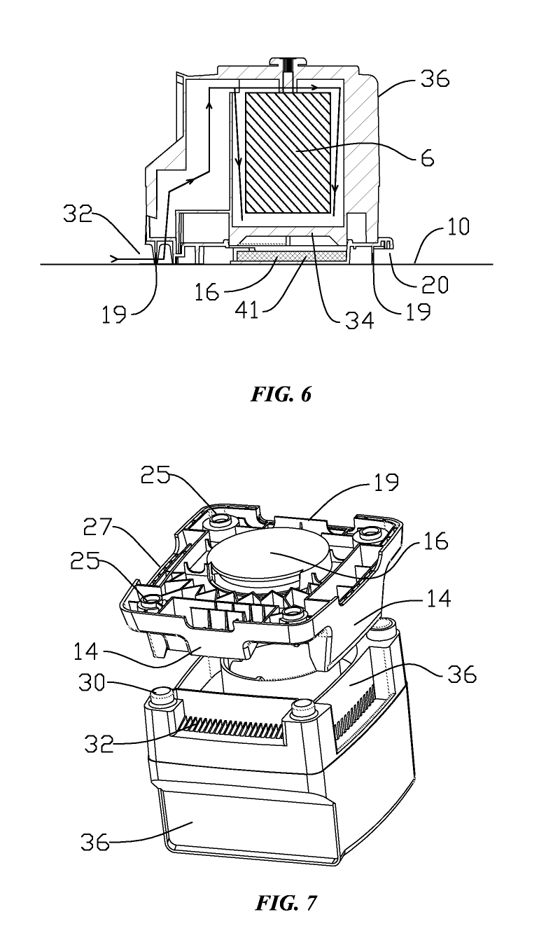

As illustrated in FIG. 6, the blender base 4 may include at least one air inlet port 32 to allow the motor 6 to draw air into the blender base 4 and cool the internal components of the blender base 4. In addition, the blender base 4 may include at least one exhaust ports 34. The exhaust port 34 allows the air drawn into the blender base 4 to be blown out of the blender base 4. The inlet port 32 may be centered along a rear side of a four-sided blender base 4. Generally, the exhaust port 34 are located at the base of the blender base 4. The number and size of the air inlet 32 and the exhaust ports 34 may vary.

The blender pad 2 generally has the same circumference shape as the blender base 4. The width and circumference of the blender pad 2, is slightly larger than the blender base 4. The blender pad 2 includes a top 11, at least one extension arm 14 and a bottom 13. Extending above the top 11, the extension arms 14 releasably clasps to the sidewall 36 of the blender base 4. When the extension arm 14 is placed against the sidewall 36, the resistance between the extension arm 14 and the sidewall 36 is such that a deliberate force is required to remove the blender pad 2. To ensure the blender pad 2 is coupled to the blender base 4, the extension arms 14 may comprise a small ridge 17 that matches grooves or the shapes in on the blender base 4. As shown in FIG. 2, the size and shape of the extension arms 14 may vary to correspond to the shape of the blender base 4. One skilled in the art will recognize that the size and length of the extension arms 14 may take on different shapes and sizes.

The blender pad 2 has several cavity 26. The cavities 26 aid in damping the noise and provided structural support. The cavities 26, may extend into the extension arms 14. The bottom of the blender pad 2, has at least two pedestals 25.

As shown in FIG. 1, the top 11 is contour such that it is similar the base of the blender base 4. Such that the top 11 has indentations for the blender base's 4 feet 30. Any other outlines or features on the blender base 4, would have a similar indentation on the top 11. When the blender pad 2 is attached to the blender base 4, the two connect with an exact fit, leaving no air pockets excepted those required for air flows or deliberately created.

The blender pad 2, has an inlet opening 18 and an exhaust opening 20. The inlet opening 18 is position near the inlet port 32 such that air drawn through the inlet port 32 is not hindered by the blender pad 2. The size of the inlet opening 18 is at least the same as the inlet port 32. The number of inlet openings 18 vary, but in practice the number of inlet openings 18 will correspond directly to the number of inlet ports 32. The inlet openings 18 may form a handle 27 located around the outer circumference of the blender pad 2. The exhaust opening 20 is located near the exhaust port 34. The size of the exhaust opening 20 is generally larger than the exhaust port 34. Both the exhaust opening 20 and the inlet opening 18 have a sound wall 19 that forces the air flow to curve through the openings. The sound wall 19 assist in damping the noise from the blender base 4.

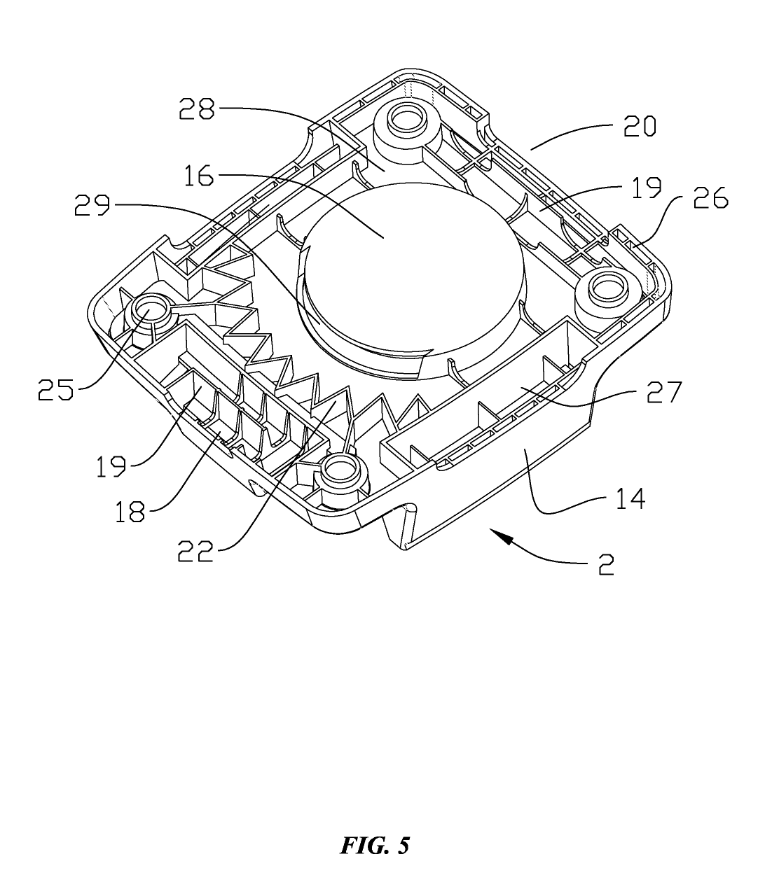

As illustrated in FIGS. 5 and 6, locate between the exhaust opening 20 and the exhaust port 34 is an acoustic chamber 16 and at least one air channel 28. The acoustic chamber 16 is located next to the exhaust port 34. The width and size of the acoustic chamber 16 is generally larger than the exhaust port 34. The acoustic chamber 16 contains an attenuating sound foam 41. The attenuating sound foam 41 is any material that absorbs noise while still allowing for air to flow through the foam 41. The attenuating sound foam 41 is the same size as the acoustic chamber 16. The acoustic chamber 16 contains an air slot 29 that allows air to flow out of the acoustic chamber 16.

Located between the air slot 29 and the exhaust opening 20 is at least one air channel 28. The air channel 28 contain an acoustic ridge 22. The acoustic ridges 22 form a corrugated edge along a portion of the air channel 28. While the acoustic ridge 22 shown have sharp angles, one skilled in the art will recognize that the acoustic ridges 22 may have other shapes. The acoustic ridge 22 is such as to absorbed any additional noise and to provide additional structural support for the blender pad 2. As shown in FIG. 5, the acoustic ridge 22 may line the air channel 28.

The blender pad 2 is made from any material which will absorbed vibrations and noise such as rubber. With the exception of the acoustic foam 41, generally the entire blender pad 2 is made from the same material.

While a preferred embodiment of the invention has been shown and described herein, it should be understood, that although the description above contains many specificities, these should not be construed as limiting the scope of the invention. Thus, the scope of the embodiment should be determined by the appended claims and their legal equivalents rather than by the examples given.

The invention claimed is:

1. A blender pad comprising:
(a) a blender, said blender having a blender base, and said blender base having side walls;
(b) a blender pad, said blender pad having an extension arm;
(c) a surface;
wherein at least a portion of the extension arm are releasably clasps to the side walls;
wherein the blender pad isolates the blender base from contact with the surface.

2. The device of claim 1, wherein said blender base further comprising an inlet port, an exhaust port;
said blender pad further comprising an inlet opening and an exhaust opening;
wherein the exhaust opening is positioned near the exhaust port;
wherein the inlet opening is positioned near the inlet port.

3. The device of claim 1, wherein said blender pad further comprising an acoustics chamber.

4. The device of claim 3, wherein said acoustic chamber having an attenuating sound foam.

5. The device of claim 3, wherein said acoustic chamber is positioned between said exhaust port and said exhaust opening.

6. The device of claim 1, wherein said blender pad comprising at least one acoustic ridge.

7. The device of claim 1, wherein said blender pad is made of rubber.

8. A method for reducing noise and vibration from a blender comprising:
(a) a blender base, said blender base having an inlet port, an exhaust port, a side wall, and a motor;
(b) a blender pad, said blender pad having an inlet opening, an exhaust opening, an extension arm, and an acoustic chamber, wherein at least a portion of the extension arm are removably clasps to the side wall;
(c) a resting surface wherein the blender pad is positioned to isolates the blender base from contact with the resting surface
(d) causing the motor to operate.

9. The method of claim 8, wherein the exhaust opening is positioned near the exhaust port;
wherein the inlet opening is positioned near the inlet port.

10. The method of claim 9, wherein said acoustic chamber is positioned between said exhaust port and said exhaust opening.

11. The method of claim 8, wherein said blender pad comprising at least one acoustics ridge.

12. The method of claim 8, wherein said blender pad is made of rubber.
